(19) United States
(12) Patent Application Publication
(10) Pub. No.: US 2023/0042572 A1
(43) Pub. Date: Feb. 9, 2023

(54) OBJECT RECOGNITION DEVICE, DRIVING ASSISTANCE DEVICE, SERVER, AND OBJECT RECOGNITION METHOD

(71) Applicant: Mitsubishi Electric Corporation, Tokyo (JP)

(72) Inventor: Yoshihiko MORI, Tokyo (JP)

(73) Assignee: Mitsubishi Electric Corporation, Tokyo (JP)

(21) Appl. No.: 17/791,949

(22) PCT Filed: Feb. 12, 2020
(86) PCT No.: PCT/JP2020/005309

§ 371 Date: Jul. 11, 2022

(51) Int. Cl. G06V 20/58; G06V 10/70

(52) U.S. Cl. CPC G06V 20/584; G06V 10/70; B60W 60/001

(57) ABSTRACT

Included are: an information acquiring unit to acquire information; a periphery recognizing unit to acquire peripheral environment information regarding a state of a peripheral environment based on the information acquired by the information acquiring unit and a first machine learning model and to acquire calculation process information indicating a calculation process when the peripheral environment information has been acquired; an explanatory information generating unit to generate explanatory information indicating information having a large influence on the peripheral environment information in the calculation process among the information acquired by the information acquiring unit based on the calculation process information acquired by the periphery recognizing unit; and an evaluation information generating unit to generate evaluation information indicating adequacy of the peripheral environment information acquired by the periphery recognizing unit based on the information acquired by the information acquiring unit and the explanatory information generated by the explanatory information generating unit.

### TECHNICAL FIELD

The present disclosure relates to an object recognition device that performs a calculation using a learned model (hereinafter referred to as “machine learning model”) in machine learning, a server, an object recognition method, and a driving assistance device that performs driving assistance of a vehicle using a calculation result by the object recognition device.

### BACKGROUND ART

Conventionally, in the field of autonomous driving and the like, technology of performing calculation using a machine learning model is known.

Meanwhile, Patent Literature 1 discloses technology of acquiring a reliability value of an assigned label for each pixel of input data on the basis of a neural network and determining whether or not each pixel is included in an error area.

### CITATION LIST

### Patent Literature

Patent Literature 1: JP 2018-73308 A

### SUMMARY OF INVENTION

### Technical Problem

The calculation processes using a machine learning model are in a so-called black box. Therefore, there is a problem that the result obtained by performing a calculation using a machine learning model is not always adequate.

In the technology disclosed in Patent Literature 1, whether or not the reliability value itself of the label acquired on the basis of the neural network is output as an adequate value is not considered in the first place. Therefore, it is not possible to use the technology disclosed in Patent Literature 1 in order to solve the above problem.

The present disclosure has been made to solve the above-described problem, and an object of the present disclosure is to provide an object recognition device that enables determination as to whether a result obtained by performing a calculation using a machine learning model is adequate.

### Solution to Problem

An object recognition device according to the present disclosure includes: an information acquiring unit to acquire information; a periphery recognizing unit to acquire peripheral environment information regarding a state of a peripheral environment on the basis of the information acquired by the information acquiring unit and a first machine learning model and to acquire calculation process information indicating a calculation process when the peripheral environment information has been acquired; an explanatory information generating unit to generate explanatory information indicating information having a large influence on the peripheral environment information in the calculation process among the information acquired by the information acquiring unit on the basis of the calculation process information acquired by the periphery recognizing unit; and an evaluation information generating unit to generate evaluation information indicating adequacy of the peripheral environment information acquired by the periphery recognizing unit on the basis of the information acquired by the information acquiring unit and the explanatory information generated by the explanatory information generating unit.

### Advantageous Effects of Invention

According to the present disclosure, it is possible to determine whether or not a result obtained by performing a calculation using a machine learning model is adequate.

### BRIEF DESCRIPTION OF DRAWINGS

FIG. 1 is a diagram illustrating a configuration example of an object recognition device according to a first embodiment.

FIGS. 2A and 2B are diagrams for describing the concept of an exemplary method in which an evaluation information generating unit calculates the degree of overlap between an area in which it is assumed that a traffic light is captured in a captured image acquired by an information acquiring unit and an area emphasized in a heat map in the first embodiment. FIG. 2A is a diagram for describing the concept of an example of the captured image acquired by the information acquiring unit, and FIG. 2B is a diagram for describing the concept of an example of the heat map as explanatory information generated by an explanatory information generating unit.

FIG. 3 is a flowchart for explaining the operation of the object recognition device according to the first embodiment.

FIG. 4 is a flowchart for explaining the operation of the object recognition device in a case where a driving assistance information acquiring unit acquires driving assistance information before determining whether or not peripheral environment information is adequate in the first embodiment.

FIG. 5 is a diagram illustrating a configuration example of an object recognition system in which some components of the object recognition device described with reference to FIG. 1 are included in a server in the first embodiment.

FIGS. 6A and 6B are diagrams each illustrating an exemplary hardware configuration of the object recognition device according to the first embodiment.

### DESCRIPTION OF EMBODIMENTS

Hereinafter, embodiments of the present invention will be described in detail with reference to the drawings.

### First Embodiment

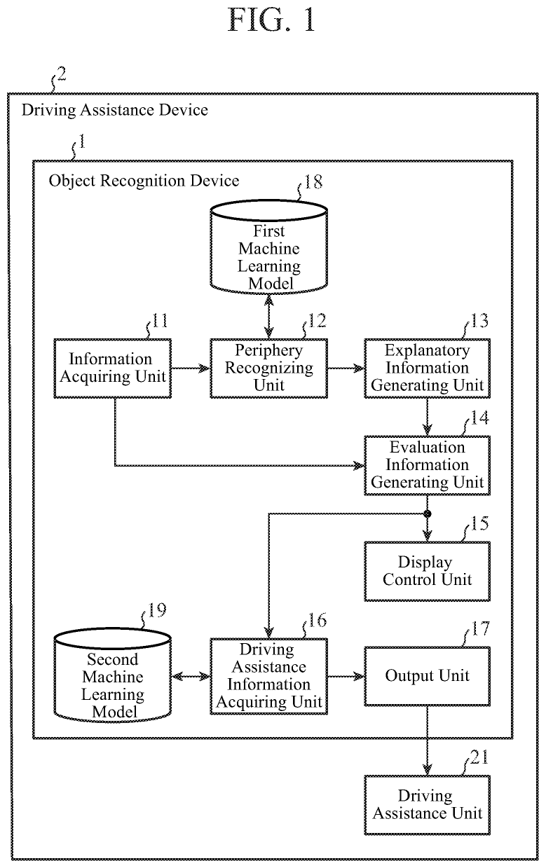

FIG. 1 is a diagram illustrating a configuration example of an object recognition device 1 according to a first embodiment.

The object recognition device 1 according to the first embodiment is included in a driving assistance device 2 mounted on a vehicle (not illustrated) and acquires information regarding the state of the peripheral environment (hereinafter referred to as “peripheral environment information”) on the basis of a first machine learning model 18. In the first embodiment, the peripheral environment information includes information related to a state of other vehicles present around a host vehicle, information related to the state of a pedestrian present around the host vehicle, topographic information, information related to the state of an obstacle present around the host vehicle, and the like. Details of the first machine learning model 18 will be described later.

At that point, the object recognition device 1 determines whether or not the peripheral environment information that has been acquired is adequate. In the first embodiment, whether or not the peripheral environment information that has been acquired is adequate specifically refers to, for example, whether or not the state of the peripheral environment recognized on the basis of the first machine learning model 18 has been adequately recognized. The object recognition device 1 determines whether or not the peripheral environment information acquired on the basis of the first machine learning model 18 is adequate depending on whether or not a calculation process for recognizing the state of the peripheral environment by the first machine learning model 18 is adequate. Details of the determination of whether or not the peripheral environment information is adequate which is performed by the object recognition device 1 will be described later.

When it is determined that the peripheral environment information that has been acquired is adequate, the object recognition device 1 outputs information for assisting driving of the vehicle (hereinafter referred to as “driving assistance information”) acquired on the basis of the peripheral environment information and a second machine learning model 19. Details of the second machine learning model 19 will be described later.

The driving assistance device 2 performs driving assistance for the vehicle on the basis of the driving assistance information output from the object recognition device 1. It is based on the premise that the vehicle for which the driving assistance device 2 assists driving has an autonomous driving function. Note that even in a case where the vehicle has an autonomous driving function, a driver can drive the vehicle by himself or herself without executing the autonomous driving function.

As illustrated in FIG. 1, the object recognition device 1 includes an information acquiring unit 11, a periphery recognizing unit 12, an explanatory information generating unit 13, an evaluation information generating unit 14, a display control unit 15, a driving assistance information acquiring unit 16, an output unit 17, the first machine learning model 18, and the second machine learning model 19.

The information acquiring unit 11 acquires information. In the first embodiment, the information acquiring unit 11 acquires information regarding the environment surrounding the vehicle. Specifically, the information regarding the environment surrounding the vehicle includes captured images obtained by imaging the outside of the vehicle, position information of the vehicle, information regarding the vehicle speed, map information, and the like.

For example, the information acquiring unit 11 acquires, from an imaging device (not illustrated) mounted on the vehicle, an outside-of-vehicle image captured by the imaging device. Furthermore, for example, the information acquiring unit 11 acquires position information and the like of the vehicle from a sensor (not illustrated) mounted on the vehicle. In addition, for example, the information acquiring unit 11 acquires map information from a map information database connected with the object recognition device 1.

The information acquiring unit 11 outputs the acquired information to the periphery recognizing unit 12 and the evaluation information generating unit 14.

The periphery recognizing unit 12 acquires peripheral environment information on the basis of the information acquired by the information acquiring unit 11 and the first machine learning model 18 and acquires information (hereinafter referred to as “calculation process information”) indicating the process of a calculation performed when the peripheral environment information has been acquired.

Here, the first machine learning model 18 is a model in which machine learning has been performed in advance by deep learning in a neural network, a convolutional neural network (CNN), or the like in such a way as to output peripheral environment information when the information regarding the environment surrounding the vehicle is input.

The periphery recognizing unit 12 inputs the information acquired by the information acquiring unit 11 to the first machine learning model 18, performs the calculation for acquiring peripheral environment information, and acquires the peripheral environment information. Note that, in the first embodiment, the first machine learning model 18 is included in the object recognition device 1 as illustrated in FIG. 1; however, this is merely an example. The first machine learning model 18 may be provided at a place outside the object recognition device 1 where the object recognition device 1 can refer to.

For example, the periphery recognizing unit 12 acquires a log of a calculation result of each layer of deep learning as calculation process information. For example, the periphery recognizing unit 12 may use the information acquired by the information acquiring unit 11 that has been input to the first machine learning model 18 and the first machine learning model 18 itself as the calculation process information. The periphery recognizing unit 12 acquires the calculation process information indicating the process of the calculation for acquiring the peripheral environment information performed using the first machine learning model 18.

The periphery recognizing unit 12 outputs the acquired peripheral environment information and calculation process information to the explanatory information generating unit 13.

On the basis of the calculation process information acquired by the periphery recognizing unit 12, the explanatory information generating unit 13 generates information (hereinafter referred to as “explanatory information”) indicating information having a large influence on the peripheral environment information in the calculation process when the periphery recognizing unit 12 has acquired the peripheral environment information among the information acquired by the information acquiring unit 11.

The explanatory information can be acquired, for example, by a known local interpretable model-agnostic explanations (LIME) method. For example, in a case where the information acquired by the information acquiring unit 11 is a captured image, the explanatory information generating unit 13 acquires a heat map indicating which part of the whole captured image is focused on using the LIME method. The explanatory information generating unit 13 uses the acquired heat map as the explanatory information.

Note that the above example is merely an example. For example, by using a part of or the whole information input to the first machine learning model 18 and a part of or the whole first machine learning model 18, the explanatory information generating unit 13 can generate explanatory information for explaining which part of the information that has been input the first machine learning model 18 has focused on in performing the calculation. Among the information that has been input, the part on which the first machine learning model 18 has focused in performing the calculation is the information having a large influence on the peripheral environment information in the calculation process of the first machine learning model 18.

The explanatory information generating unit 13 outputs the explanatory information that has been generated to the evaluation information generating unit 14. The explanatory information generating unit 13 outputs the peripheral environment information acquired from the periphery recognizing unit 12 to the evaluation information generating unit 14 together with the explanatory information.

The evaluation information generating unit 14 generates information (hereinafter referred to as “evaluation information”) indicating adequacy of the peripheral environment information acquired by the periphery recognizing unit 12 on the basis of the information acquired by the information acquiring unit 11 and the explanatory information generated by the explanatory information generating unit 13.

For example, let us presume that the information acquired by the information acquiring unit 11 is a captured image and that the periphery recognizing unit 12 has acquired information of a traffic light as peripheral environment information on the basis of the captured image and the first machine learning model 18. The information of the traffic light is indicated by, for example, coordinates on the captured image. Let us also presume that the explanatory information generated by the explanatory information generating unit 13 is a heat map. In this case, it means that the first machine learning model 18 has recognized the traffic light by focusing on a part emphasized in the heat map. In other words, it means that in the calculation process in which the periphery recognizing unit 12 recognizes the traffic light, the influence of the part emphasized in the heat map is large.

The evaluation information generating unit 14 compares the area in which it is assumed that the traffic light is captured in the captured image acquired by the information acquiring unit 11 with the area emphasized in the heat map and evaluates how much the areas overlap with each other. Specifically, for example, the evaluation information generating unit 14 calculates the degree how much the area in which it is assumed that the traffic light is captured in the captured image and the area emphasized in the heat map overlap with each other. The evaluation information generating unit 14 may set, as the degree of overlap, a ratio (%) at which the area emphasized in the heat map overlaps the area in which it is assumed that the traffic light is captured in the captured image, or may set, as the degree of overlap, a numerical value representing the ratio (%) in 0 to 1.

A specific method by which the evaluation information generating unit 14 calculates the degree of overlap between the area in which it is assumed that the traffic light is captured in the captured image and the area emphasized in the heat map will be described with an example.

For example, a rough area (hereinafter referred to as “environment narrowing area”) for narrowing down to an area in which it is assumed that the peripheral environment information is imaged in the captured image is set in advance depending on the peripheral environment information recognized by the periphery recognizing unit 12. The evaluation information generating unit 14 first specifies the environment narrowing area on the captured image depending on the peripheral environment information recognized by the periphery recognizing unit 12. Here, for example, the upper half area of the captured image is set in advance as the environment narrowing area corresponding to the traffic light on the captured image. In this case, the evaluation information generating unit 14 first specifies the upper half area of the captured image.

Then the evaluation information generating unit 14 narrows down the environment narrowing area to an area in which it is assumed that the peripheral environment information is captured. For example, the evaluation information generating unit 14 narrows down to the area in which it is assumed that the peripheral environment information is captured from a change in luminance in the environment narrowing area on the captured image. Here, the evaluation information generating unit 14 narrows down to an area in which there is a change in luminance in the environment narrowing area on the captured image as an area in which it is assumed that the traffic light is captured.

Then, the evaluation information generating unit 14 calculates the degree of overlap between the narrowed area and the area emphasized in the heat map.

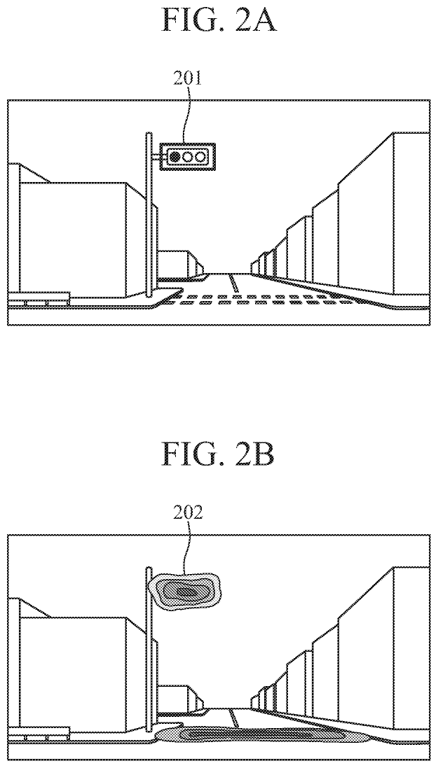

Here, FIGS. 2A and 2B are diagrams for describing the concept of an exemplary method in which the evaluation information generating unit 14 calculates the degree of overlap between an area in which it is assumed that a traffic light is captured in a captured image acquired by the information acquiring unit 11 and an area emphasized in a heat map in the first embodiment. Specifically, FIG. 2A is a diagram for describing the concept of an example of the captured image acquired by the information acquiring unit 11, and FIG. 2B is a diagram for describing the concept of an example of the heat map as explanatory information generated by the explanatory information generating unit 13.

In FIG. 2A, an area in which there has been a change in luminance in the environment narrowing area on the captured image, to which the evaluation information generating unit 14 has been narrowed down as the area in which it is assumed that the traffic light is captured, is denoted by 201.

The area denoted by 201 in FIG. 2A is entirely included in the area denoted by 202 in FIG. 2B.

Therefore, the evaluation information generating unit 14 calculates the degree of overlap as “100%”. The evaluation information generating unit 14 may calculate the degree of overlap as “1”.

In the above example, the evaluation information generating unit 14 narrows down the area in which it is assumed that the traffic light is captured from the environment narrowing area; however, for example, the evaluation information generating unit 14 may determine the area in which it is assumed that the traffic light is captured in the captured image using known image recognition technology. The evaluation information generating unit 14 calculates the degree of overlap between the area in which it is assumed that the traffic light is captured, the area being determined using known image recognition technology, and the area emphasized in the heat map.

After calculating the degree of overlap, the evaluation information generating unit 14 sets information indicating the degree of overlap as evaluation information.

Note that the above example is merely an example. The evaluation information generating unit 14 is only required to generate evaluation information indicating whether or not the peripheral environment information acquired by the periphery recognizing unit 12 is adequate on the basis of the information acquired by the information acquiring unit 11 and the explanatory information generated by the explanatory information generating unit 13.

The evaluation information generating unit 14 outputs the evaluation information that has been generated to the display control unit 15 and the driving assistance information acquiring unit 16. The evaluation information generating unit 14 outputs the peripheral environment information acquired by the periphery recognizing unit 12 together with the evaluation information to the display control unit 15 and the driving assistance information acquiring unit 16.

The evaluation information generating unit 14 may output the explanatory information generated by the explanatory information generating unit 13 together with the evaluation information to the display control unit 15 and the driving assistance information acquiring unit 16.

The display control unit 15 displays information based on the evaluation information generated by the evaluation information generating unit 14.

The display control unit 15 displays the evaluation information on a display device (not illustrated). The display device is installed, for example, on the instrument panel of the vehicle.

The display control unit 15 determines whether or not the peripheral environment information recognized by the periphery recognizing unit 12 is adequate on the basis of the evaluation information generated by the evaluation information generating unit 14 and can control the content of the information to be displayed on the display device depending on the determination result. The display control unit 15 determines whether or not the peripheral environment information is adequate on the basis of whether or not the evaluation information generated by the evaluation information generating unit 14 satisfies a preset condition (hereinafter referred to as “evaluation determination condition”).

As a specific example, for example, let us presume that the evaluation determination condition is that “evaluation information is more than or equal to an evaluation determination threshold value”. Note that, at this point, evaluation information is, for example, information expressed by a numerical value from 0 to 1. It is shown that the larger the numerical value is, the more adequate the peripheral environment information is.

In a case where the evaluation information is more than or equal to the evaluation determination threshold value, the display control unit 15 determines that the peripheral environment information is adequate. Specifically, for example in a case where the evaluation determination threshold value is “0.7” and the evaluation information is “0.8”, the display control unit 15 determines that the peripheral environment information is adequate. In this case, the display control unit 15 displays the evaluation information on the display device. Specifically, for example, the display control unit 15 displays “0.8”. The display control unit 15 may display the evaluation information as a message indicating that the peripheral environment information is adequate, such as “OK”.

On the other hand, in a case where the evaluation information is less than the evaluation determination threshold value, the display control unit 15 determines that the peripheral environment information is not adequate. Specifically, for example in a case where the evaluation determination threshold value is “0.7” and the evaluation information is “0.4”, the display control unit 15 determines that the peripheral environment information is not adequate. In this case, the display control unit 15 displays the explanatory information generated by the explanatory information generating unit 13 on the display device in addition to the evaluation information. Specifically, the display control unit 15 displays “0.4” and the heat map, for example. Note that it is based on the premise that the explanatory information is the heat map. The display control unit 15 may display a message indicating that the peripheral environment information is not adequate, such as “NG”, and the heat map.

The driving assistance information acquiring unit 16 acquires driving assistance information on the basis of the peripheral environment information acquired by the periphery recognizing unit 12 and the second machine learning model 19. Note that the driving assistance information acquiring unit 16 may acquire the peripheral environment information acquired by the periphery recognizing unit 12 from the evaluation information generating unit 14.

More specifically, when determining that the peripheral environment information acquired by the periphery recognizing unit 12 is adequate on the basis of the evaluation information generated by the evaluation information generating unit 14, the driving assistance information acquiring unit 16 acquires driving assistance information on the basis of the peripheral environment information acquired by the periphery recognizing unit 12 and the second machine learning model 19. When determining that the peripheral environment information acquired by the periphery recognizing unit 12 is not adequate on the basis of the evaluation information generated by the evaluation information generating unit 14, the driving assistance information acquiring unit 16 does not acquire the driving assistance information.

The driving assistance information acquiring unit 16 determines whether or not the peripheral environment information is adequate depending on whether or not the evaluation information generated by the evaluation information generating unit 14 satisfies the evaluation determination condition. It is based on the premise that the evaluation determination condition adopted by the driving assistance information acquiring unit 16 is the same condition as the evaluation determination condition adopted for the display control unit 15 to determine whether or not peripheral environment information is adequate.

As a specific example, let us presume that the evaluation determination condition is that “evaluation information is more than or equal to an evaluation determination threshold value”. Note that, at this point, evaluation information is, for example, information expressed by a numerical value from 0 to 1. It is shown that the larger the numerical value is, the more adequate the peripheral environment information is. In a case where the evaluation information is more than or equal to the evaluation determination threshold value, the driving assistance information acquiring unit 16 determines that the peripheral environment information is adequate. Specifically, for example in a case where the evaluation determination threshold value is “0.7” and the evaluation information is “0.8”, the driving assistance information acquiring unit 16 determines that the peripheral environment information is adequate.

On the other hand, in a case where the evaluation information is less than the evaluation determination threshold value, the driving assistance information acquiring unit 16 determines that the peripheral environment information is not adequate. Specifically, for example in a case where the evaluation determination threshold value is “0.7” and the evaluation information is “0.4”, the driving assistance information acquiring unit 16 determines that the peripheral environment information is not adequate.

When determining that the peripheral environment information is adequate, the driving assistance information acquiring unit 16 inputs the peripheral environment information acquired by the periphery recognizing unit 12 to the second machine learning model 19, performs calculation for acquiring driving assistance information, and acquires the driving assistance information. The driving assistance information is, for example, information for controlling driving of the vehicle, such as information regarding an opening degree of the brake, information regarding the speed, or information regarding the steering wheel angle. Furthermore, the driving assistance information may be, for example, information provided to a driver of the vehicle as a user, such as a notification indicating that there is a traffic jam or an obstacle.

The second machine learning model 19 is a model in which machine learning has been performed in advance by deep learning in a neural network, a CNN, or the like in such a way as to output driving assistance information when peripheral environment information is input.

Note that, in the first embodiment, the second machine learning model 19 is included in the object recognition device 1 as illustrated in FIG. 1; however, this is merely an example. The second machine learning model 19 may be provided at a place outside the object recognition device 1 where the object recognition device 1 can refer to.

When acquiring the driving assistance information, the driving assistance information acquiring unit 16 outputs the driving assistance information that has been acquired to the output unit 17.

The output unit 17 outputs the driving assistance information acquired by the driving assistance information acquiring unit 16 to the driving assistance device 2.

When the driving assistance information is output from the object recognition device 1, the driving assistance device 2 performs driving assistance of the vehicle on the basis of the driving assistance information.

Specifically, the driving assistance unit 21 included in the driving assistance device 2 performs driving assistance of the vehicle on the basis of the driving assistance information acquired by the driving assistance information acquiring unit 16 in the object recognition device 1.

Note that in a case where the driving assistance information is not output from the object recognition device 1, in the driving assistance device 2, the driving assistance unit 21 switches the driving of the vehicle to manual driving, for example. For example, the driving assistance unit 21 may perform driving assistance of the vehicle in accordance with information output from an external device (not illustrated) other than the object recognition device 1.

The operation of the object recognition device 1 of the first embodiment will be described.

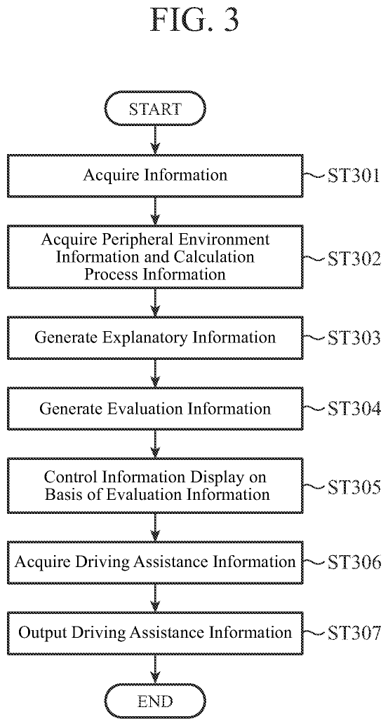

FIG. 3 is a flowchart for explaining the operation of the object recognition device 1 according to the first embodiment.

The information acquiring unit 11 acquires information (step ST301).

The information acquiring unit 11 outputs the acquired information to the periphery recognizing unit 12 and the evaluation information generating unit 14.

The periphery recognizing unit 12 acquires peripheral environment information on the basis of the information acquired by the information acquiring unit 11 in step ST301 and the first machine learning model 18 and acquires calculation process information (step ST302).

The periphery recognizing unit 12 outputs the acquired peripheral environment information and calculation process information to the explanatory information generating unit 13.

The explanatory information generating unit 13 generates explanatory information on the basis of the calculation process information acquired by the periphery recognizing unit 12 in step ST302 (step ST303).

The explanatory information generating unit 13 outputs the explanatory information that has been generated to the evaluation information generating unit 14. The explanatory information generating unit 13 outputs the peripheral environment information acquired from the periphery recognizing unit 12 to the evaluation information generating unit 14 together with the explanatory information.

The evaluation information generating unit 14 generates evaluation information on the basis of the information acquired by the information acquiring unit 11 in step ST301 and the explanatory information generated by the explanatory information generating unit 13 in step ST303 (step ST304).

The evaluation information generating unit 14 outputs the evaluation information that has been generated to the display control unit 15 and the driving assistance information acquiring unit 16. The evaluation information generating unit 14 outputs the peripheral environment information acquired by the periphery recognizing unit 12 in step ST302 together with the evaluation information to the display control unit 15 and the driving assistance information acquiring unit 16.

The evaluation information generating unit 14 may output the explanatory information generated by the explanatory information generating unit 13 together with the evaluation information to the display control unit 15 and the driving assistance information acquiring unit 16.

The display control unit 15 displays information based on the evaluation information generated by the evaluation information generating unit 14 in step ST304 (step ST305).

Specifically, the display control unit 15 determines whether or not the peripheral environment information recognized by the periphery recognizing unit 12 is adequate on the basis of the evaluation information generated by the evaluation information generating unit 14 and controls the content of the information to be displayed on the display device depending on the determination result.

The driving assistance information acquiring unit 16 acquires driving assistance information on the basis of the peripheral environment information acquired by the periphery recognizing unit 12 in step ST302 and the second machine learning model 19 (step ST306).

More specifically, when determining that the peripheral environment information acquired by the periphery recognizing unit 12 in step ST302 is adequate on the basis of the evaluation information generated by the evaluation information generating unit 14 in step ST305, the driving assistance information acquiring unit 16 acquires driving assistance information on the basis of the peripheral environment information acquired by the periphery recognizing unit 12 and the second machine learning model 19. When determining that the peripheral environment information acquired by the periphery recognizing unit in step ST302 is not adequate on the basis of the evaluation information generated by the evaluation information generating unit 14 in step ST305, the driving assistance information acquiring unit 16 does not acquire the driving assistance information.

When acquiring the driving assistance information, the driving assistance information acquiring unit 16 outputs the driving assistance information that has been acquired to the output unit 17.

The output unit 17 outputs the driving assistance information acquired by the driving assistance information acquiring unit 16 in step ST306 to the driving assistance device 2 (step ST307).

When the driving assistance information is output from the object recognition device 1, the driving assistance device 2 performs driving control of the vehicle on the basis of the driving assistance information.

Specifically, the driving assistance unit 21 included in the driving assistance device 2 performs driving control of the vehicle on the basis of the driving assistance information acquired by the driving assistance information acquiring unit 16 in the object recognition device 1.

Note that the order of the operation of step ST305 and the operation of step ST306 may be reversed, or the operation of step ST305 and the operation of step ST306 may be performed in parallel.

As described above, the object recognition device 1 according to the first embodiment acquires the peripheral environment information on the basis of the information that has been acquired and the first machine learning model 18 and the calculation process information. On the basis of the calculation process information, the object recognition device 1 generates the explanatory information indicating information having a large influence on the peripheral environment information in the calculation process of the peripheral environment information among the information that has been acquired. Then, the object recognition device 1 evaluates the adequacy of the peripheral environment information on the basis of the information that has been acquired and the explanatory information and generates the evaluation information indicating the adequacy.

As a result, the object recognition device 1 can determine whether or not the result obtained by performing the calculation using the first machine learning model 18 is adequate. That is, the object recognition device 1 can determine whether or not the peripheral environment information, which is a result of recognizing the peripheral environment using the first machine learning model 18, is adequate.

In the first embodiment, the object recognition device 1 displays information based on the evaluation information generated by the evaluation information generating unit. As a result, the driver of the vehicle can visually recognize that the object recognition device 1 has been able to acquire adequate peripheral environment information.

In addition, the object recognition device 1 performs display control in such a way that only the evaluation information is displayed in a case where the adequacy of the peripheral environment information is evaluated to be high and performs display control in such a way that the explanatory information as well as the evaluation information is displayed in a case where the adequacy of the peripheral environment information is evaluated to be low. As described above, the object recognition device 1 can reduce the amount of information to be displayed in a case where adequate peripheral environment information has been acquired. As a result, the object recognition device 1 can reduce the driver's workload in monitoring whether or not peripheral environment information has been acquired when the adequate peripheral environment information has been successfully acquired.

Moreover, in the first embodiment, the object recognition device 1 acquires driving assistance information on the basis of the peripheral environment information that has been acquired and the second machine learning model 19. Therefore, since the object recognition device 1 determines the adequacy of the peripheral environment information and then acquires driving assistance information on the basis of the peripheral environment information and the second machine learning model 19, the peripheral environment information that has been acquired can be adequately used in acquiring the driving assistance information.

More specifically, when determining that the peripheral environment information is adequate on the basis of the evaluation information that has been generated, the object recognition device 1 acquires the driving assistance information. When determining that the peripheral environment information is not adequate on the basis of the evaluation information, the object recognition device 1 does not acquire driving assistance information. Therefore, since the object recognition device 1 determines the adequacy of the peripheral environment information and then acquires driving assistance information on the basis of the peripheral environment information and the second machine learning model 19, the peripheral environment information that has been acquired can be adequately used in acquiring the driving assistance information.

In the first embodiment described above, as described in the flowchart of FIG. 3, the driving assistance information acquiring unit 16 determines whether or not the peripheral environment information acquired by the periphery recognizing unit 12 is adequate on the basis of the evaluation information generated by the evaluation information generating unit 14 and then acquires driving assistance information when it is determined that the peripheral environment information is adequate. However, without limited to this, and the driving assistance information acquiring unit 16 may acquire the driving assistance information before it is determined whether or not the peripheral environment information is adequate on the basis of the evaluation information. In this case, the driving assistance information acquiring unit 16 determines whether or not the peripheral environment information is adequate and, when determining that the peripheral environment information is adequate, outputs the driving assistance information that has been acquired to the output unit 17. When determining that the peripheral environment information is not adequate, the driving assistance information acquiring unit 16 does not output the driving assistance information that has been acquired.

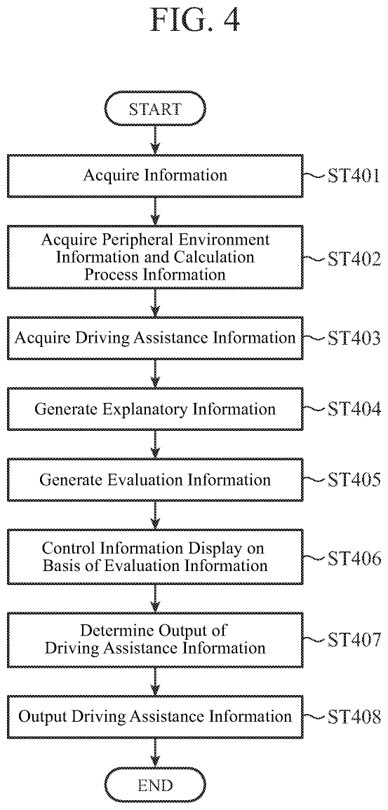

FIG. 4 is a flowchart for explaining the operation of the object recognition device 1 in a case where the driving assistance information acquiring unit 16 acquires driving assistance information before determining whether or not peripheral environment information is adequate in the first embodiment.

The specific operations in steps ST401 to ST402, steps ST404 to ST406, and step ST408 in FIG. 4 are similar to the specific operations in steps ST301 to ST305 and step ST307 in FIG. 3, respectively, and thus redundant description is omitted.

In step ST403, the driving assistance information acquiring unit 16 acquires driving assistance information on the basis of the peripheral environment information acquired by the periphery recognizing unit 12 in step ST402 and the second machine learning model 19.

In step ST407, the driving assistance information acquiring unit 16 determines whether or not the peripheral environment information acquired by the periphery recognizing unit 12 in step ST402 is adequate on the basis of the evaluation information generated by the evaluation information generating unit 14 in step ST405.

When determining that the peripheral environment information is adequate, the driving assistance information acquiring unit 16 determines to output the driving assistance information that has been acquired in step ST402. When determining that the peripheral environment information is not adequate, the driving assistance information acquiring unit 16 determines not to output the driving assistance information that has been acquired in step ST402.

When determining to output the driving assistance information, the driving assistance information acquiring unit 16 outputs the driving assistance information that has been acquired to the output unit 17.

Note that the operation of step ST403 may be performed before the operation of step ST405 is completed. Note that the order of the operation of step ST406 and the operation of step ST407 may be reversed, or the operation of step ST406 and the operation of step ST407 may be performed in parallel.

In the first embodiment described above, the object recognition device 1 has the configuration as illustrated in FIG. 1; however, the object recognition device 1 does not necessarily include the display control unit 15, the driving assistance information acquiring unit 16, the output unit 17, nor the second machine learning model 19.

For example, in a case where the object recognition device 1 does not include the display control unit 15, the operations of step ST305 in FIG. 3 and step ST406 in FIG. 4 are not performed in the operation of the object recognition device 1.

For example, in a case where the object recognition device 1 does not include the driving assistance information acquiring unit 16, the output unit 17, and the second machine learning model 19, in the operation of the object recognition device 1, the operations of steps ST306 to ST307 in FIG. 3 and steps ST403 and ST407 to ST408 in FIG. 4 are not performed.

In the first embodiment described above, it is based on the premise that the object recognition device 1 is mounted on a vehicle; however, this is merely an example.

For example, some of the components of the object recognition device 1 described with reference to FIG. 1 may be included in a server 3.

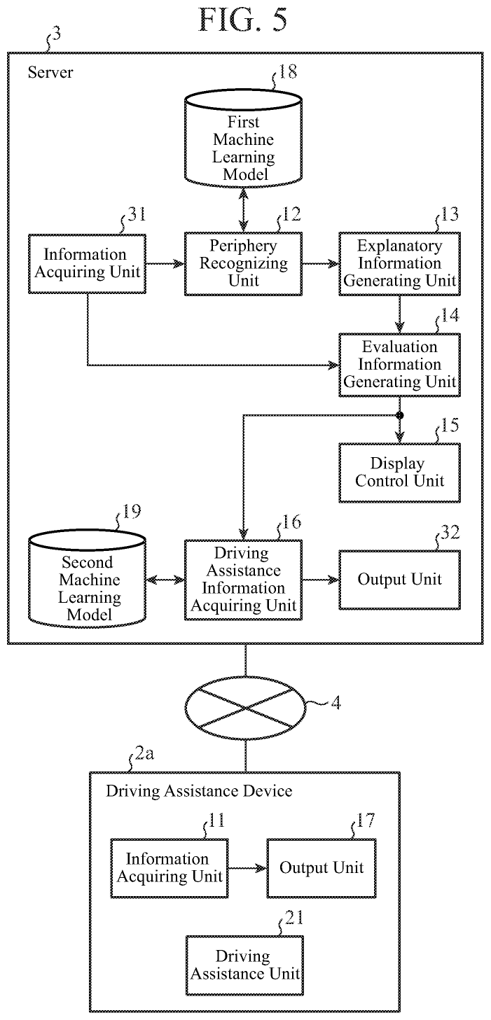

FIG. 5 is a diagram illustrating a configuration example of an object recognition system in which some of the components of the object recognition device 1 described with reference to FIG. 1 in the first embodiment are included in a server 3.

In FIG. 5, out of the components of the object recognition device 1 described with reference to FIG. 1, the information acquiring unit 11 and the output unit 17 are included in a driving assistance device 2a mounted on a vehicle, and the periphery recognizing unit 12, the explanatory information generating unit 13, the evaluation information generating unit 14, the display control unit 15, the driving assistance information acquiring unit 16, the first machine learning model 18, and the second machine learning model 19 are included in a server 3, and the driving assistance device 2a and the server 3 are included in an object recognition system. The driving assistance device 2a and server 3 are connected via a network 4.

The server 3 further includes an information acquiring unit 31 and an output unit 32 in addition to the above components.

The information acquiring unit 31 of the server 3 acquires information from the information acquiring unit 11. The information acquiring unit 31 outputs the information that has been acquired to the periphery recognizing unit 12.

The output unit 32 of the server 3 outputs driving assistance information to a driving assistance unit 21.

Meanwhile, in FIG. 5, it is based on the premise that there is one vehicle; however, this is merely an example. A plurality of vehicles each mounted with the driving assistance device 2a may be connected with the server 3.

In this case, in the server 3, the output unit 32 may output the driving assistance information to the driving assistance device 2a that is the output source that has output the information acquired by the information acquiring unit 31 or may output the driving assistance information to a driving assistance device 2a mounted on a vehicle different from that of the driving assistance device 2a.

Description will be given with a specific example. In the following specific example, one or more driving assistance devices 2a different from the driving assistance device 2a that has output the information to the server 3 are referred to as “other driving assistance devices”. In addition, a vehicle on which the driving assistance device 2a is mounted is referred to as “host vehicle”, and vehicles on which the “other driving assistance devices” are mounted are referred to as “other vehicles”. It is based on the premise that a captured image obtained by capturing the periphery of the host vehicle is output from the driving assistance device 2a of the host vehicle to the server 3. The server 3 acquires peripheral environment information on the basis of the captured image and the first machine learning model 18 and determines adequacy of the peripheral environment information.

For example, let us presume that there is a queue of vehicles in which one or more other vehicles are jammed behind the host vehicle with the host vehicle being at the head. Let us presume that the server 3 acquires peripheral environment information indicating that there is an obstacle such as a fallen rock on the basis of the captured image acquired from the driving assistance device 2a and the first machine learning model 18. Let us further presume that the server 3 determines that the peripheral environment information that has been acquired is adequate. In this case, the server 3 outputs driving assistance information acquired on the basis of the peripheral environment information and the second machine learning model 19 to the driving assistance device 2a. The driving assistance information is, for example, information for controlling the opening degree of the brake. At this point, the server 3 can output the driving assistance information not only to the driving assistance device 2a but also to other driving assistance devices mounted on other vehicles jammed behind the host vehicle.

In addition, for example, let us presume that the host vehicle is caught in a traffic jam when the host vehicle and other vehicles have been traveling from different starting points to the same destination. Let us presume that the server 3 acquires peripheral environment information indicating that there is a traffic jam on the basis of the captured image acquired from the driving assistance device 2a and the first machine learning model 18. Let us further presume that the server 3 determines that the peripheral environment information that has been acquired is adequate. In this case, the server 3 outputs driving assistance information acquired on the basis of the peripheral environment information and the second machine learning model 19 to the driving assistance device 2a. The driving assistance information is, for example, information for notifying the driver that there is a traffic jam. At this point, the server 3 can output the driving assistance information not only to the driving assistance device 2a but also to other driving assistance devices mounted on other vehicles in traveling toward the same destination.

In this manner, the server 3 can output the driving assistance information to the driving assistance devices 2a mounted on a plurality of vehicles in which the same control is performed or a plurality of vehicles that need to be provided with the same information.

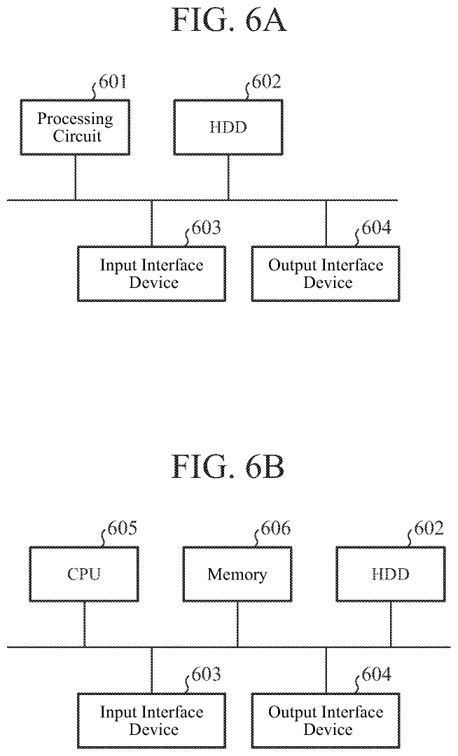

FIGS. 6A and 6B are diagrams each illustrating an exemplary hardware configuration of the object recognition device 1 according to the first embodiment.

In the first embodiment, the functions of the information acquiring unit 11, the periphery recognizing unit 12, the explanatory information generating unit 13, the evaluation information generating unit 14, the display control unit 15, the driving assistance information acquiring unit 16, and the output unit 17 are implemented by a processing circuit 601. That is, the object recognition device 1 includes the processing circuit 601 for evaluating the adequacy of the peripheral environment information acquired on the basis of information, displaying the peripheral environment information on the basis of the evaluation of the adequacy, or acquiring driving assistance information on the basis of the peripheral environment information.

The processing circuit 601 may be dedicated hardware as illustrated in FIG. 6A or may be a central processing unit (CPU) 605 for executing a program stored in a memory 606 as illustrated in FIG. 6B.

In a case where the processing circuit 601 is dedicated hardware, the processing circuit 601 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit 601 is the CPU 605, the functions of the information acquiring unit 11, the periphery recognizing unit 12, the explanatory information generating unit 13, the evaluation information generating unit 14, the display control unit 15, the driving assistance information acquiring unit 16, and the output unit 17 are implemented by software, firmware, or a combination of software and firmware. That is, the information acquiring unit 11, the periphery recognizing unit 12, the explanatory information generating unit 13, the evaluation information generating unit 14, the display control unit 15, the driving assistance information acquiring unit 16, and the output unit 17 are implemented by the CPU 605 that executes a program stored in a hard disk drive (HDD) 602, the memory 606, or the like or a processing circuit 601 such as a system large scale integration (LSI). It can also be said that the programs stored in the HDD 602, the memory 606, and the like cause a computer to execute the procedures or methods performed by the information acquiring unit 11, the periphery recognizing unit 12, the explanatory information generating unit 13, the evaluation information generating unit 14, the display control unit 15, the driving assistance information acquiring unit 16, and the output unit 17. Here, the memory 606 may be, for example, a nonvolatile or volatile semiconductor memory such as a RAM, a read only memory (ROM), a flash memory, an erasable programmable read only memory (EPROM), or an electrically erasable programmable read only memory (EEPROM), a magnetic disc, a flexible disc, an optical disc, a compact disc, a mini disc, or a digital versatile disc (DVD).

Note that some of the functions of the information acquiring unit 11, the periphery recognizing unit 12, the explanatory information generating unit 13, the evaluation information generating unit 14, the display control unit 15, the driving assistance information acquiring unit 16, and the output unit 17 may be implemented by dedicated hardware, and some of them may be implemented by software or firmware. For example, the functions of the information acquiring unit 11 and the output unit 17 can be implemented by the processing circuit 601 as dedicated hardware, and the functions of the periphery recognizing unit 12, the explanatory information generating unit 13, the evaluation information generating unit 14, the display control unit 15, and the driving assistance information acquiring unit 16 can be implemented by the processing circuit 601 reading and executing the programs stored in the memory 606.

The object recognition device 1 further includes an input interface device 603 and an output interface device 604 for performing wired communication or wireless communication with a device such as the display device (not illustrated) or the server 3.

As described above, according to the first embodiment, the object recognition device 1 includes: the information acquiring unit 11 that acquires information; the periphery recognizing unit 12 that acquires peripheral environment information regarding the state of the peripheral environment on the basis of the information acquired by the information acquiring unit 11 and the first machine learning model 18 and acquires calculation process information indicating a calculation process when the peripheral environment information has been acquired; the explanatory information generating unit 13 that generates explanatory information indicating information having a large influence on the peripheral environment information in the calculation process among the information acquired by the information acquiring unit 11 on the basis of the calculation process information acquired by the periphery recognizing unit 12; and the evaluation information generating unit 14 to generate evaluation information indicating adequacy of the peripheral environment information acquired by the periphery recognizing unit 12 on the basis of the information acquired by the information acquiring unit 11 and the explanatory information generated by the explanatory information generating unit 13. Therefore, the object recognition device 1 can determine whether or not the result obtained by performing the calculation using the machine learning model (first machine learning model 18) is adequate.

Furthermore, according to the first embodiment, the object recognition device 1 can include the display control unit 15 that displays information based on the evaluation information generated by the evaluation information generating unit 14. Thus, the user can visually recognize that the object recognition device 1 has been able to acquire adequate peripheral environment information.

Furthermore, according to the first embodiment, it is possible to configure that, in the object recognition device 1, the information acquiring unit 11 acquires information around the vehicle and include the driving assistance information acquiring unit 16 that acquires driving assistance information on the basis of the peripheral environment information acquired by the periphery recognizing unit 12 and the second machine learning model 19. Therefore, since the object recognition device 1 determines the adequacy of the peripheral environment information and then acquires driving assistance information on the basis of the peripheral environment information and the second machine learning model 19, the peripheral environment information that has been acquired can be adequately used in acquiring the driving assistance information.

In the first embodiment described above, the object recognition device 1 acquires peripheral environment information regarding the state of the environment around the vehicle and determines the adequacy of the peripheral environment information; however, this is merely an example.

For example, the object recognition device 1 can be applied to a device that acquires, as calculation result information, information regarding a position where a screw is screwed on the basis of an image and a machine learning model in a factory and determines adequacy of the calculation result information.

For example, when determining that the calculation result information that has been acquired is adequate, the object recognition device 1 outputs assistance information for controlling the screwing to a screwing machine on the basis of the calculation result information.

As described above, the object recognition device 1 according to the first embodiment can be applied to various devices that acquire the calculation result information on the basis of the information that has been acquired and a machine learning model and can determine whether or not the result obtained by performing a calculation using the machine learning model is adequate in the various devices.

Note that the present invention may include modifications of any component of the embodiment or omission of any component of the embodiment within the scope of the invention.

### INDUSTRIAL APPLICABILITY

An object recognition device according to the present invention is configured to determine whether a result obtained by performing a calculation using a machine learning model is adequate and thus can be applied to an object recognition device that performs a calculation using a machine learning model.

### REFERENCE SIGNS LIST

1: object recognition device,

11, 31: information acquiring unit,

12: periphery recognizing unit,

13: explanatory information generating unit,

14: evaluation information generating unit,

15: display control unit,

16: driving assistance information acquiring unit,

17, 32: output unit,

18: first machine learning model,

19: second machine learning model,

2, 2a: driving assistance device,

21: driving assistance unit,

3: server,

4: network,

601: processing circuit,

602: HDD,

603: input interface device,

604: output interface device,

605: CPU,

606: memory

1. An object recognition device comprising:
processing circuitry configured to
acquire information;
acquire peripheral environment information regarding a state of a peripheral environment on a basis of the acquired information and a first machine learning model and to acquire calculation process information indicating a calculation process when the peripheral environment information has been acquired;
generate explanatory information indicating information having a large influence on the peripheral environment information in the calculation process among the acquired information on a basis of the acquired calculation process information; and
generate evaluation information indicating adequacy of the acquired peripheral environment information on a basis of the acquired information and the generated explanatory information.

2. The object recognition device according to claim 1,
wherein the processing circuitry is further configured to
display information based on the generated evaluation information.

3. The object recognition device according to claim 1,
wherein the processing circuitry is further configured to
acquire driving assistance information on a basis of the acquired peripheral environment information and a second machine learning model, and
acquire information of a periphery of a vehicle.

4. The object recognition device according to claim 3,
wherein the processing circuitry acquires the driving assistance information in a case where it is determined that the acquired peripheral environment information is adequate on a basis of the generated evaluation information, and
the processing circuitry does not acquire the driving assistance information in a case where it is determined that the acquired peripheral environment information is not adequate on a basis of the generated evaluation information.

5. A driving assistance device comprising:
the object recognition device according to claim 3; and
a driving assistant to perform driving control of the vehicle on a basis of the acquired driving assistance information.

6. A server comprising:
processing circuitry configured to
acquire information;
acquire peripheral environment information regarding an object present in a peripheral environment on a basis of the acquired information and a first machine learning model and to acquire calculation process information indicating a calculation process by the first machine learning model when the peripheral environment information has been acquired;
generate explanatory information indicating information having a large influence on the peripheral environment information in the calculation process on a basis of the acquired calculation process information.
generate evaluation information indicating adequacy of the acquired peripheral environment information on a basis of the acquired information and the generated explanatory information; and
output the generated evaluation information to an external device.

7. The server according to claim 6, further comprising:
a display controller to display the generated evaluation information.

8. The server according to claim 6,
wherein the processing circuitry is further configured to
acquire driving assistance information on a basis of the acquired peripheral environment information and a second machine learning model,
wherein the external device is a vehicle,
the processing circuitry acquires information of a periphery of the vehicle, and
outputs the acquired driving assistance information to the vehicle.

9. The server according to claim 8,
wherein the processing circuitry acquires the driving assistance information in a case where it is determined that the acquired peripheral environment information is adequate on a basis of the generated evaluation information, and
the processing circuitry does not acquire the driving assistance information in a case where it is determined that the acquired peripheral environment information is not adequate on a basis of the generated evaluation information.

10. An object recognition method comprising:
acquiring information;
acquiring peripheral environment information regarding a state of a peripheral environment on a basis of the acquired information and a first machine learning model and acquiring calculation process information indicating a calculation process when the peripheral environment information has been acquired;
generating explanatory information indicating information having a large influence on the peripheral environment information in the calculation process among the acquired information on a basis of the acquired calculation process information; and
generating evaluation information indicating adequacy of the acquired peripheral environment information on a basis of the acquired information and the generated explanatory information.
